(19) United States
(12) Patent Application Publication
(10) Pub. No.: US 2018/0038277 A1
(43) Pub. Date: Feb. 8, 2018

(54) CLOSED-LOOP GAS TURBINE GENERATOR

(71) Applicant: KING FAHD UNIVERSITY OF PETROLEUM AND MINERALS, DHAHRAN (SA)

(72) Inventors: MOHAMED ABDEL-AZIZ HABIB, DHAHRAN (SA); PERVEZ AHMED, DHAHRAN (SA); MEDHAT A. NEMITALLAH, DHAHRAN (SA)

(73) Assignee: KING FAHD UNIVERSITY OF PETROLEUM AND MINERALS

(21) Appl. No.: 15/229,094

(22) Filed: Aug. 4, 2016

(51) Int. Cl. F02C 3/10; F02C 6/00; H02K 7/18; F02C 3/36

(52) U.S. Cl. CPC F02C 3/10; F02C 3/36; F02C 6/003; H02K 7/1823

(57) ABSTRACT

The closed-loop gas turbine generator is a combustion-based gas reactor for producing usable power to drive external loads. A combustion chamber produces combustion products for driving a first gas turbine, which may be connected to an external load. Exhaust from the first gas turbine is fed to an oxygen transport reactor, which produces carbon dioxide and water as output products. The carbon dioxide and water drive a second gas turbine, which may also be connected to an external load. The first gas turbine drives a compressor, which produces compressed air. Heat exchange between the compressed air and exhaust from the second gas turbine produces a stream of heated air, which is fed back to the combustion chamber in a closed-loop cycle.

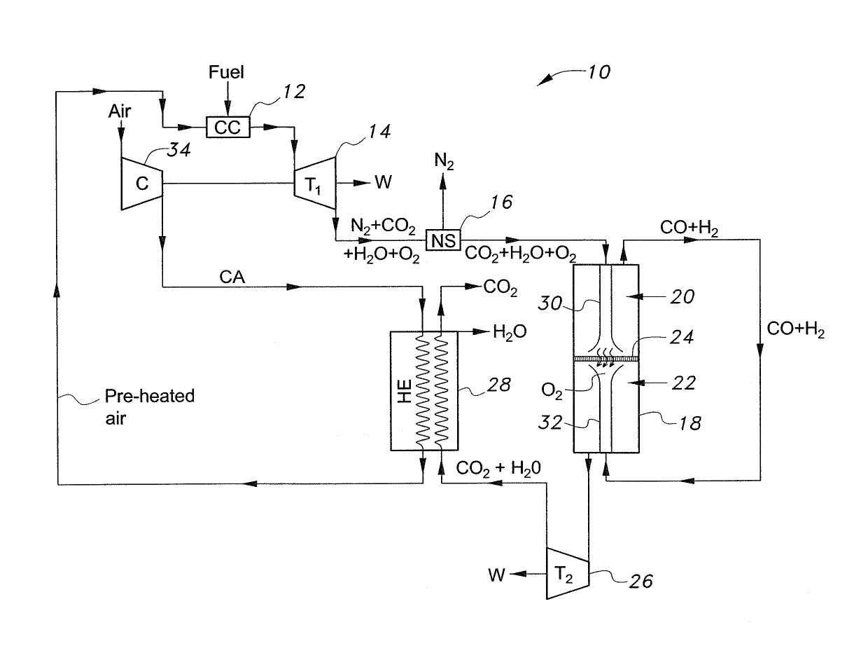

### BACKGROUND OF THE INVENTION

### 1. Field of the Invention

The present invention relates to power production, and particularly to a closed-loop gas turbine generator utilizing an oxygen transport reactor.

### 2. Description of the Related Art

A typical gas turbine generator makes use of a combustion chamber in communication with a gas turbine. A hydrocarbon fuel (such as propane or the like) is fed into the combustion chamber, along with a stream of air as an oxygen source, where the fuel is combusted, resulting in carbon dioxide, water, nitrogen, excess oxygen and heat. The heated exhaust gases are fed to the gas turbine, for the driving thereof, and the gas turbine may then be connected to an external load for providing power thereto.

The carbon dioxide produced by such combustion reactions is a major component of the greenhouse gases that are presently causing global climate change. Although it would be impossible to combust hydrocarbons without the production of carbon dioxide, it would obviously be desirable to be able to minimize the amount of carbon dioxide emitted into the atmosphere during hydrocarbon-based power production. Further, since the air-to-fuel ratio in gas turbines is typically very high, it would be further desirable to be able to make use of the excess oxygen to increase the efficiency of the system, thus further decreasing the carbon dioxide emissions.

Thus, a closed-loop gas turbine generator addressing the aforementioned problems is desired.

### SUMMARY OF THE INVENTION

The closed-loop gas turbine generator is a combustion-based gas reactor for producing usable power to drive external loads. The closed-loop gas turbine generator includes a combustion chamber for combusting pre-heated air and fuel input thereto. A first gas turbine is in communication with the combustion chamber and is driven by combustion products produced thereby. The first gas turbine may be connected to an external load for delivering power thereto, either through direct mechanical interconnection for driving a mechanical load, or by driving an electrical generator for producing electrical power. A compressor is also driven by the first gas turbine to compress environmental air into a stream of compressed air.

An oxygen transport reactor receives a first gas turbine exhaust output from the first gas turbine. The oxygen transport reactor has a feed side and a permeate side, which are separated from one another by an ion transport membrane. The ion transport membrane is selective to oxygen, only allowing oxygen to pass therethrough. The first gas turbine exhaust output from the first gas turbine is fed into the feed side of the oxygen transport reactor, and the ion transport membrane selectively transports oxygen therefrom to the permeate side. This leaves a syngas in the feed side, which is then extracted and externally transported to the permeate side to react with the oxygen therein. The reaction of the syngas with the oxygen produces carbon dioxide and water.

A second gas turbine is in communication with the oxygen transport reactor and is driven by the carbon dioxide and the water produced in the permeate side thereof. The second gas turbine may also be connected to an external load for delivering power thereto. As with the first gas turbine, the second gas turbine may either have a direct mechanical interconnection for driving a mechanical load, or may drive an electrical generator for producing electrical power.

A heat exchanger receives the stream of compressed air produced by the compressor, as well as the second gas turbine exhaust output from the second gas turbine. Thermal transfer between the stream of compressed air and the second gas turbine exhaust produces the pre-heated air fed to the combustion chamber.

These and other features of the present, invention will become readily apparent upon further review of the following specification and drawing.

### BRIEF DESCRIPTION OF THE DRAWINGS

The sole drawing FIGURE is a schematic diagram of a closed-loop gas turbine generator according to the present invention.

### DETAILED DESCRIPTION OF THE PREFERRED EMBODIMENTS

The closed-loop gas turbine generator 10 is a combustion-based gas reactor for producing usable power to drive external loads. As shown in the sole drawing FIGURE, the closed-loop gas turbine generator 10 includes a combustion chamber (CC) 12 for combusting pre-heated air and fuel input thereto. It should be understood that the combustion chamber 12 may be any suitable type of combustion chamber for combusting a hydrocarbon fuel, as is conventionally known. The products produced by the combustion chamber 12 include a mixture of nitrogen (N₂), carbon dioxide (CO₂), water (H₂O) and oxygen (O₂) gases. A first gas turbine 14 (labeled T₁ in the sole FIGURE) is in communication with the combustion chamber 12 and is driven by the combustion products produced thereby. The first gas turbine 14 may be connected to an external load for delivering power thereto, either through direct mechanical interconnection for driving a mechanical load (i.e., mechanical work W), or by driving an electrical generator for producing electrical power. A compressor (C) 34 is also driven by the first gas turbine 14 to compress environmental air into a stream of compressed air (CA).

An oxygen transport reactor 18 receives a first gas turbine exhaust output from the first gas turbine 14. Preferably, as shown, a nitrogen separator (NS) 16 removes nitrogen gas from the first gas turbine exhaust output prior to injection thereof into the oxygen transport reactor 18. Thus, the oxygen transport reactor 18 receives a mixture of carbon dioxide, water and oxygen gases. The removal of nitrogen from the first gas turbine exhaust output assists in the operation of the oxygen transport reactor 18. As will be described in greater detail below, the oxygen transport reactor 18 includes an ion transport membrane 24 for the permeation of oxygen therethrough. The permeation of oxygen across the membrane 24 depends on the partial pressure difference across the membrane. Removal of the nitrogen from the first gas turbine exhaust aids in producing higher oxygen partial pressure on the feed side of the membrane 24.

The oxygen transport reactor 18 has a feed side 20 and a permeate side 22, which are separated from one another by the ion transport membrane 24. The ion transport membrane 24 is selectively permeable to oxygen, only allowing oxygen (O₂) to pass therethrough. The first gas turbine exhaust output from the first gas turbine 14 is fed into the feed side 20 of the oxygen transport reactor 18, and the ion transport membrane 24 selectively transports oxygen (O₂) therefrom to the permeate side 22. The water vapor in the first gas turbine exhaust is split (by the oxygen permeation across the membrane 24), resulting in hydrogen gas. Similarly, the carbon dioxide is also split, resulting in carbon monoxide gas. The mixture of carbon monoxide (CO) and hydrogen (H₂) gases is a syngas produced in the feed side 20.

The syngas is extracted from the feed side 20 and externally transported to the permeate side 22 to react with the oxygen therein (i.e., the O₂ transported across the ion transport membrane 24). The reaction of the syngas with the oxygen produces carbon dioxide (CO₂) and water (H₂O). As shown in the sole FIGURE, a first diffuser 30 is preferably mounted in the feed side 20, and a second diffuser 32 is preferably mounted in the permeate side 22. The first diffuser 30 receives the first gas turbine exhaust and outputs the first gas turbine exhaust uniformly within the feed side 20, thus providing a high degree of oxygen concentration. Similarly, the second diffuser 32 receives the syngas and outputs the syngas uniformly within the permeate side 22 for providing greater stability for the membrane 24. The reaction of the syngas with the oxygen in the permeate side 22 reduces the partial pressure of oxygen in the permeate side 22, further enhancing the permeation rate of oxygen across the membrane 24. Permeation of oxygen across the membrane 24 is also aided by the relatively high temperature of the first turbine exhaust gases, which are fed into the oxygen transport reactor 18.

A second gas turbine 26 (labeled as T₂ in the sole FIGURE) is in communication with the oxygen transport reactor 18 and is driven by carbon dioxide (CO₂) and water (H₂O) produced in the permeate side 22. The second gas turbine 26 may also be connected to an external load for delivering power thereto. As with the first gas turbine, the second gas turbine 26 may either have a direct mechanical interconnection for driving a mechanical load (i.e., mechanical work W), or may drive an electrical generator for producing electrical power.

A heat exchanger (HE) 28 receives the stream of compressed air CA produced by the compressor 34 as well as the second gas turbine exhaust (CO₂ and H₂O) output from the second gas turbine 26. Thermal transfer between the stream of compressed air CA and the second gas turbine exhaust produces pre-heated air fed to the combustion chamber 12, forming the closed loop cycle. The pre-heating of the compressed air CA improves energy conservation by reducing the fuel flow rate into the combustion chamber 12, thus improving overall system efficiency. The heat exchange results in condensation of the water, which can then be easily separated out, leaving behind only carbon dioxide gas. The remaining carbon dioxide (which may still contain traces of water) may either then be collected for storage or may be re-introduced into the oxygen transport reactor 18 (with the first gas turbine exhaust) for a continued cyclic process.

It is to be understood that the present invention is not limited to the embodiments described above, but encompasses any and all embodiments within the scope of the following claims.

We claim:

1. A closed-loop gas turbine generator, comprising:
a combustion chamber for combustion of pre-heated air and fuel therein;
a first gas turbine connected to the combustion chamber and driven by combustion products produced by the combustion chamber, the first gas turbine being adapted for connection to an external load for delivering power thereto;
a compressor driven by the first gas turbine to compress air into a stream of compressed air;
an oxygen transport reactor connected to the first gas turbine, the oxygen transport reactor having a feed side, a permeate side, and an ion transport membrane disposed between the feed side and the permeate side, the ion transport membrane being selectively permeable to oxygen, the oxygen transport reactor further having a bypass conduit connecting the feed side with the permeate side, exhaust output from the first gas turbine being fed into the feed side of the oxygen transport reactor, wherein oxygen in the exhaust output on the feed side is transported through the ion transport membrane to the permeate side, leaving syngas on the feed side, the syngas being fed through the bypass conduit to the permeate side for combustion with the transported oxygen, producing carbon dioxide and water;
a second gas turbine connected to the oxygen transport reactor and driven by the carbon dioxide and the water exhaust produced in the permeate side of the oxygen transport reactor, the second gas turbine being adapted for connection to an external load for delivering power thereto; and
a heat exchanger connected to the compressor and the second gas turbine for receiving the stream of compressed air produced by said compressor and the exhaust output from said second gas turbine, thermal transfer between the stream of compressed air and the second gas turbine exhaust producing the pre-heated air fed to the combustion chamber.

2. The closed-loop gas turbine generator as, recited in claim 1, further comprising a nitrogen separator disposed between said first gas turbine and said oxygen transport reactor for separating out nitrogen gas from the first gas turbine exhaust prior to the first gas turbine exhaust being fed into the feed side of said oxygen transport reactor.

3. The closed-loop gas turbine generator as recited in claim 1, further comprising a first diffuser mounted in the feed side of said oxygen transport reactor for receiving the first gas turbine exhaust and outputting the first gas turbine exhaust uniformly within the feed side of said oxygen transport reactor.

4. The closed-loop gas turbine generator as recited in claim 3, further comprising a second diffuser mounted in the permeate side of said oxygen transport reactor for receiving the syngas and outputting the syngas uniformly within the permeate side of said oxygen transport reactor.

5. A closed-loop gas turbine generator, comprising:
a combustion chamber for combustion of pre-heated air and fuel therein;
a first gas turbine connected to the combustion chamber and driven by combustion products produced by the combustion chamber, the first gas turbine being adapted for connection to an external load for delivering power thereto;
a compressor driven by the first gas turbine to compress air into a stream of compressed air;
an oxygen transport reactor connected to the first gas turbine, the oxygen transport reactor having a feed side, a permeate side, and an ion transport membrane disposed between the feed side and the permeate side, the ion transport membrane being selectively permeable to oxygen, the oxygen transport reactor further having a bypass conduit connecting the feed side with the permeate side, exhaust output from the first gas turbine being fed into the feed side of the oxygen transport reactor, wherein oxygen in the exhaust output on the feed side is transported through the ion transport membrane to the permeate side, leaving syngas on the feed side, the syngas being fed through the bypass conduit to the permeate side for combustion with the transported oxygen, producing carbon dioxide and water;
a first diffuser mounted in the feed side of the oxygen transport reactor for receiving the first gas turbine exhaust and outputting the first gas turbine exhaust uniformly within the feed side;
a second diffuser mounted in the permeate side of the oxygen transport reactor for receiving the syngas and outputting the syngas uniformly within the permeate side;
a second gas turbine connected to the oxygen transport reactor and driven by the carbon dioxide and the water exhaust produced in the permeate side of the oxygen transport reactor, the second gas turbine being adapted for connection to an external load for delivering power thereto; and
a heat exchanger connected to the compressor and the second gas turbine for receiving the stream of compressed air produced by said compressor and the exhaust output from said second gas turbine, thermal transfer between the stream of compressed air and the second gas turbine exhaust producing the pre-heated air fed to the combustion chamber.

6. The closed-loop gas turbine generator as recited in claim 5, further comprising a nitrogen separator disposed between said first gas turbine and said oxygen transport reactor for separating out nitrogen gas from the first gas turbine exhaust prior to the first gas turbine exhaust being fed into the feed side of said oxygen transport reactor.

7. A closed-loop gas turbine generator, comprising:
a combustion chamber for combustion of pre-heated air and fuel therein;
a first gas turbine connected to the combustion chamber and driven by combustion products produced by the combustion chamber, the first gas turbine being adapted for connection to an external load for delivering power thereto;
a compressor driven by the first gas turbine to compress air into a stream of compressed air;
an oxygen transport reactor connected to the first gas turbine, the oxygen transport reactor having a feed side, a permeate side, and an ion transport membrane disposed between the feed side and the permeate side, the ion transport membrane being selectively permeable to oxygen, the oxygen transport reactor further having a bypass conduit connecting the feed side with the permeate side, exhaust output from the first gas turbine being fed into the feed side of the oxygen transport reactor, wherein oxygen in the exhaust output on the feed side is transported through the ion transport membrane to the permeate side, leaving syngas on the feed side, the syngas being fed through the bypass conduit to the permeate side for combustion with the transported oxygen, producing carbon dioxide and water;
a nitrogen separator disposed between said first gas turbine and said oxygen transport reactor for separating out nitrogen gas from the first gas turbine exhaust prior to the first gas turbine exhaust being fed into the feed side of said oxygen transport reactor;
a second gas turbine connected to the oxygen transport reactor and driven by the carbon dioxide and the water exhaust produced in the permeate side of the oxygen transport reactor, the second gas turbine being adapted for connection to an external load for delivering power thereto; and
a heat exchanger connected to the compressor and the second gas turbine for receiving the stream of compressed air produced by said compressor and the exhaust output from said second gas turbine, thermal transfer between the stream of compressed air and the second gas turbine exhaust producing the pre-heated air fed to the combustion chamber.

8. The closed-loop gas turbine generator as recited in claim 7, further comprising a first diffuser mounted in the feed side of said oxygen transport reactor for receiving the first gas turbine exhaust and outputting the first gas turbine exhaust uniformly within the feed side of said oxygen transport reactor.

9. The closed-loop gas turbine generator as recited in claim 8, further comprising a second diffuser mounted in the permeate side of said oxygen transport reactor for receiving the syngas and outputting the syngas uniformly within the permeate side of said oxygen transport reactor.
